(19) United States
(12) Patent Application Publication
(10) Pub. No.: US 2026/0070397 A1
(43) Pub. Date: Mar. 12, 2026

(54) LAMINATED PANE HAVING REFLECTIVE SURFACE APPLIED IN CERTAIN REGIONS

(71) Applicant: SAINT-GOBAIN SEKURIT FRANCE, Thourotte (FR)

(72) Inventors: Jan HAGEN, HERZOGENRATH (DE); Michael MÜLLER, HERZOGENRATH (DE); Andreas GOMER, HERZOGENRATH (DE); Oliver GIER, HERZOGENRATH (DE)

(21) Appl. No.: 19/107,334

(22) PCT Filed: Aug. 25, 2023
(86) PCT No.: PCT/EP2023/073319

§ 371 Date: Feb. 27, 2025

(30) Foreign Application Priority Data
Aug. 30, 2022 (EP) 22192941.7

(51) Int. Cl. B60J 1/02; B32B 17/10; B32B 38/00

(52) U.S. Cl. CPC B60J 1/02; B32B 17/1055; B32B 38/0012; B32B 2038/0016; B32B 2038/0064; B32B 2250/05; B32B 2250/40; B32B 2274/00; B32B 2307/41; B32B 2307/416; B32B 2309/105; B32B 2311/22; B32B 2311/30; B32B 2605/08

(57) ABSTRACT

A laminated pane includes at least an outer pane, a thermoplastic intermediate layer, an inner pane, at least one masking layer arranged in a region of the laminated pane, an adhesive layer, and a metal foil having an outer-side surface and an interior-side surface on which a reflective surface for reflecting light is arranged. The thermoplastic intermediate layer is arranged between the outer pane and the inner pane, the adhesive layer is arranged between the inner pane and the metal foil, and the metal foil is arranged in a region of the laminated pane which, when viewed perpendicularly through the laminated pane, lies completely within the region in which the masking layer is arranged.

The invention relates to a laminated pane having a reflective surface applied in certain regions, a method for the production and use thereof, and to a projection assembly.

Modern automobiles are increasingly equipped with so-called head-up displays (HUD's). By means of a projector, typically in the region of the dashboard, images are projected onto the windshield, reflected there, and perceived by the driver as a virtual image behind the windshield. Thus, important information can be projected into the field of vision of the driver, for example, the current travel speed, navigation messages or warnings that the driver can perceive without having to turn his gaze away from the road. Head-up displays can accordingly contribute substantially to increasing traffic safety.

However, head-up displays often have the problem that the region of the windshield which is provided for reflection of the light projected by the projector has to have a high transparency of generally at least 70%. The reflected light of the projector is thus overlaid with light from the external environment, which, depending on the light conditions, can lead to a reduction in contrast of the virtual image and thus to a poorer visual perception for the driver. A sufficient visual perception of, in particular, safety-relevant information such as lane assistance, speed display or rotational speed of the motor should be ensured in all weather and light conditions. It would thus be desirable to have a projection assembly which is based on head-up display technology in which no undesired secondary images occur and the arrangement of which is relatively easy to accomplish with good discernability with sufficient brightness and contrast of the displayed image information. In order to achieve this, it is necessary to increase the contrast in the reflection region of the windshield. The contrast increase can be achieved, for example, by the background of the reflection region being largely or completely opaque. However, such solutions require that a reflective layer is applied only in a locally limited region of the windshield.

The application of metallic coatings to glass panes is usually effected by means of sputtering, in particular magnetron sputtering. During sputtering, atoms are released from a target by bombardment with ions. By means of physical vapor deposition, in an evacuated chamber the glass pane is coated with the atoms released from the target. The atoms move, guided by electric fields, through the chamber towards the glass pane. They move from the cathode, on which the target is arranged, towards the anode. Due to the arrangement of the glass pane between the cathode and the anode, a layer forms on the glass pane. In the case of magnetron sputtering, an additional magnetic field is arranged behind the cathode, which leads to faster layer growth and a denser, i.e. less porous, layer. Methods in which sputtering is used to coat glass panes are known, for example, from WO 9900528A1, DE 10126868C1 and WO 2017198363A1.

Magnetron sputtering is thus also suitable for coating glass panes because, unlike many other coating technologies, it can also be used if the glass pane is curved, as is the case with glass panes intended for the automotive sector, for example. However, a disadvantage with sputtering is that without special precautions, specific surface regions cannot be coated selectively, but rather the entire surface is always coated. The selective coating of only certain surface regions can be achieved, for example, by laborious masking of the regions that are not to be coated. Such masking can only be integrated into the industrial series production of coated glass panes with considerable effort and is bound up with relatively high costs.

Cold gas spraying is also a suitable method for coating glass panes and is a coating process generally known to a person skilled in the art, by means of which a powder is applied at very high velocity to a carrier. Methods for coating by means of cold gas spraying are known, for example, from WO 2010/003396 A1, EP 3 845 685 A1 and EP 2 902 530 A1.

The object of the present invention is to provide an improved laminated pane having a reflective surface applied in certain regions. In particular, the laminated pane is to be easy to manufacture.

The object of the present invention is achieved according to the invention by a laminated pane according to Claim 1. Preferred embodiments are apparent from the dependent claims.

The laminated pane according to the invention comprises an outer pane, a thermoplastic intermediate layer, at least one masking layer, an inner pane, an adhesive layer and a metal foil. The thermoplastic intermediate layer is arranged between the outer pane and the inner pane, and the adhesive layer is arranged between the inner pane and the metal foil. According to the invention, the at least one masking layer is arranged in a region of the laminated pane and the metal foil is arranged in a region of the laminated pane which, when viewed perpendicularly through the laminated pane, lies completely within the region in which the at least one masking layer is arranged.

The laminated pane is provided to separate the interior from the external environment in a window opening of a vehicle. Within the meaning of the invention, the term “inner pane” refers to the pane of the laminated pane facing the vehicle interior. Outer pane means the pane facing the external environment.

The laminated pane has in particular an upper edge and a lower edge, and two side edges extending between them. Upper edge means the edge intended to point upwards in the installed position. Lower edge means the edge intended to point downward in the installed position. In the case of a windshield, the upper edge is often also referred to as the roof edge and the lower edge is referred to as the motor edge.

The outer pane, the inner pane and the metal foil in each case have an outer-side and an interior-side surface and a peripheral side edge extending between them. Within the meaning of the invention, the outer-side surface means the main surface which is intended to face the external environment when installed. Within the meaning of the invention, the interior-side surface means the main surface which is intended to face the interior when installed. The interior-side surface of the outer pane and the outer-side surface of the inner pane face one another and are connected to one another by the thermoplastic intermediate layer.

The outer-side surface of the outer pane is designated as side I. The interior-side surface of the outer pane is designated as side II. The outer-side surface of the inner pane is designated as side III. The interior-side surface of the inner pane is designated as side IV. The outer-side surface of the metal foil is designated as side V. The interior-side surface of the metal foil is designated as side VI.

According to one embodiment, the inner pane is arranged between the outer pane and the metal foil (the metal foil is arranged on the interior-side surface (side IV) of the inner pane). In this case, the interior-side surface of the inner pane and the outer-side surface of the metal foil face one another. According to a further embodiment, the metal foil is arranged between the outer pane and the inner pane (metal foil is arranged on the outer-side surface (side III) of the inner pane). In this case, the outer-side surface of the inner pane and the interior-side surface of the metal foil face one another. The interior-side surface of the outer pane and the outer-side surface of the inner pane always face one another.

According to the invention, the metal foil is thin and preferably has a thickness of less than 200 μm (micrometers), in particular less than 100 μm. Such a metal foil is flexible and can be advantageously adapted to the curvature of a pane.

The metal foil is not an electrical conductor. In particular, the metal foil is not joined to a transparent, electrically conductive coating or any other electrically conductive structure of the laminated pane for transmitting electrical power. In particular, the metal foil is arranged in or on the laminated pane in an electrically insulated manner.

According to the invention, a reflective surface for reflecting light is arranged on the interior-side surface of the metal foil. In a preferred embodiment of the invention, the interior-side surface of the metal foil itself is provided as a reflective surface. In this case, there is no further coating or layer serving to reflect light on the interior-side surface of the metal foil, i.e. the reflective surface is formed by the material of the metal foil. Alternatively, however, it is also possible and provided according to the invention that the interior-side surface of the metal foil is provided with a coating or layer serving to reflect light, for example a smoothing layer, such as a nickel coating, which is applied in particular by electroplating to the interior-side surface of the metal foil. In this case, the smoothing layer provides the reflective surface. Such a smoothing layer can reduce the roughness of the interior-side surface of the metal foil, i.e. the reflective surface becomes smoother and has even better reflectivity.

In the installed state of the laminated pane in a vehicle, the reflective surface is at a shorter distance from the vehicle interior than at least one masking layer, so that the imaging unit of a projection assembly arranged in the vehicle interior has a direct view of the reflective surface and the reflective surface can reflect light emitted by the imaging unit. It is also possible that an additional masking layer is arranged closer to the vehicle interior than the reflective surface. In order to ensure a direct view of the imaging unit onto the reflective surface in this case, this additional masking layer has one or more openings, so that the light from the imaging unit is reflected from the reflective surface and can be viewed by a viewer in the vehicle interior.

Due to the fact that the metal foil is arranged in a region of the laminated pane which, when viewed perpendicularly through the laminated pane, lies completely within the region in which at least one masking layer is arranged, the reflective surface formed by the metal foil is also arranged in a region which, when viewed perpendicularly through the laminated pane, lies completely within the region in which the masking layer is arranged. The reflective surface is thus arranged in a perpendicular view through the laminated pane or in an orthogonal projection through the laminated pane to cover or overlap the masking layer. The reflective surface (or metal foil) thus has no portion that is not covered by the masking layer, i.e. the reflective surface is only formed where it is in front of the masking layer in a view of the inner side of the laminated pane. This ensures high contrast and brightness and thus good discernability of the virtual image reflected from the reflective surface.

As described above, the reflective surface serves to reflect light. The reflective surface is preferably light-impermeable or partially transparent, which within the meaning of the invention means that it has an average transmission (according to ISO 9050:2003) in the visible spectral range of preferably at most 80%, particularly preferably at most 50%, and in particular less than 10%. The reflective surface preferably reflects at least 10%, particularly preferably at least 50%, and very particularly preferably at least 80%, and in particular at least 90% of the light impinging upon the reflective surface. The reflective layer preferably reflects p-polarized and s-polarized light in equal proportions, but it can also reflect p-polarized light and s-polarized light to different degrees. In one embodiment, the light reflected by the reflective surface predominantly comprises p-polarized light, so that the virtual image is clearly visible even when using s-polarizing sunglasses. Methods for determining the relative proportion of reflected light are known to a person skilled in the art. In this connection, reference is made to the standard DIN EN 410-2011-04. The relative proportion of reflected light can be determined by a light source (e.g. light type A) and a detector on the same side of the reflective surface, wherein the light is directed onto the reflective surface at an angle of 80° to the normal, for example.

The light reflected by the reflective surface is preferably visible light, i.e. light in a wavelength range of approximately 380 nm to 780 nm. The reflective surface preferably has a high and uniform reflectance (via different irradiation angles) with regard to p-polarized and/or s-polarized radiation, so that a strong and color-neutral image presentation is ensured.

The indication of the polarization direction refers to the plane of incidence of the radiation on the laminated pane. P-polarized radiation refers to a radiation the electric field of which oscillates in the plane of incidence. S-polarized radiation refers to a radiation the electric field of which oscillates perpendicular to the plane of incidence. The plane of incidence is spanned by the incident vector and the surface normal of the laminated pane in the geometric center of the irradiated region.

In other words, the polarization, i.e. in particular the proportion of p- and s-polarized radiation, is determined at a point of the region irradiated by the image display device—preferably in the geometric center of the irradiated region. Since laminated panes can be curved (for example, when formed as a windshield), which has effects upon the plane of incidence of the image display device radiation, polarization components slightly deviating therefrom can occur in the other regions, which is unavoidable for physical reasons.

In an advantageous embodiment of the laminated pane according to the invention, the metal foil consists of stainless steel. Such metal foils are readily available and inexpensive.

In a further advantageous embodiment of the laminated pane according to the invention, with which the reflective surface is formed by the metal foil itself (i.e. by the material of the metal foil), the reflective surface of the metal foil (i.e. the outer-side surface of the metal foil) is polished and the interior-side surface of the metal foil is roughened. On the one hand, this can ensure good reflectivity of the reflective surface. On the other hand, adhesion to the inner pane is improved by the adhesive layer. Relatively expressed, the interior-side surface is rougher than the outer-side surface of the metal foil or reflective surface.

The reflective surface can optionally be provided with a smoothing layer, for example a nickel coating, in order to improve reflectivity.

In a further advantageous embodiment of the laminated pane according to the invention, at least the reflective surface, in particular the complete outer-side surface (side VI) of the metal foil, is provided with a protective layer. The protective layer is preferably transparent and applied to the reflective surface over the entire surface, in particular congruently. The protective layer is, for example, a polymer based on polyacrylates, polyoximes, alkyd resins, polyurethanes or mixtures thereof. Preferably, the protective layer contains SiO₂, Si₃N4 or TiO₂, or consists thereof.

The protective layer protects the reflective surface from mechanical damage, such as scratches. It can also serve to increase the durability of the reflective surface.

The protective layer preferably has a thickness of 50 nm to 10 μm and particularly preferably of 100 nm to 5 μm.

In a particularly preferred embodiment of the invention, the protective layer is a layer that is easy to clean and/or is an “anti-fingerprint” layer. Within the meaning of the invention, “layer that is easy to clean” means that dirt in the form of, for example, fingerprints, grease spots and dirt particles on the protective layer can be removed from the protective layer by using a cloth and preferably a microfiber cloth. Grease-dissolving or abrasive cleaning agents and solvents, for example based on alcohols, are therefore largely avoided for the cleaning of the protective layer. Within the meaning of the invention, “anti-fingerprint” means a layer in which fingerprints that adhere to the protective layer are hardly or not at all perceptible visually. The term “fingerprints” refers in particular to the grease-containing components of a human finger that remain on a surface when a surface is touched and can be unaesthetic.

In a preferred embodiment of the laminated pane according to the invention, a reflective surface for reflecting light is arranged on the interior-side surface of the metal foil and a protective layer is arranged on this reflective surface.

As described above, in the laminated pane according to the invention at least one masking layer is arranged in one region of the laminated pane. The masking layer is preferably arranged in an edge region of the laminated pane, which is typically adjacent to the pane edge of the pane. The great advantage of this arrangement is obtained when the laminated pane in a vehicle is used as a windshield, because the masking layer when arranged in an edge region lies outside the main viewing region of the driver.

The masking layer is preferably arranged at least along the lower edge and adjacent to the lower edge. This results in a rectangular opaque strip, which is arranged along the lower edge, when looking onto the laminated pane.

In a particular embodiment of the laminated pane according to the invention, the masking layer is designed to run peripherally in a frame-like manner. In a portion in which the metal foil, and thus also the reflective surface applied to it, is arranged to cover the masking layer, the frame-like masking layer is preferably provided with a widening, i.e. it has a greater width (dimension perpendicular to the extension) than in other portions. In this way, the masking layer can be adapted in a suitable manner to the dimensions of the metal foil with the reflective surface applied to it. In one embodiment, the masking layer is thus designed to be peripheral in a frame-like manner, and in particular has a greater width in a portion that overlaps with the metal foil than in portions different therefrom.

The metal foil with the reflective surface applied to it is preferably substantially in the form of a rectangle that extends between the two side edges in a region near the lower edge. Particularly preferably, the edges of the metal foil do not reach the side edges and the bottom edge, but are, for example, 2 cm to 5 cm distant from them.

The metal foil can be easily cut to a suitable size, so that the production of the metal foil can be easily integrated into the processes of industrial series production of laminated panes.

The masking layer within the meaning of the invention is a layer that prevents the view through the laminated pane. In this case, at most 5%, preferably at most 2%, particularly preferably at most 1%, in particular at most 0.1%, of the light of the visible spectrum is transmitted through the masking layer. The masking layer is thus an opaque masking layer, preferably a black masking layer.

The masking layer is preferably a coating made up of one or more layers. Alternatively, the masking layer can also be a colored region of the thermoplastic intermediate layer. According to a preferred embodiment of the laminated pane, the masking layer consists of a single layer. This has the advantage of a particularly simple and cost-effective manufacture of the laminated pane because only a single layer has to be formed for the masking layer. The masking layer is in particular an opaque masking print made of a dark, preferably black, enamel.

Advantageously, the at least one masking layer is formed as an opaque masking print arranged on the interior-side surface (side II) of the outer pane, in particular made of a dark, preferably black, enamel. Alternatively or in addition, the masking layer is formed as an opaque masking print, in particular made of a dark, preferably black, enamel, arranged on the outer-side surface (side III) of the inner pane. In particular, a first opaque masking print can be arranged on the interior-side surface (side II) of the outer pane and a second opaque masking print on the outer-side surface (side III) of the inner pane.

If the metal foil is arranged on the outer-side surface (side III) of the inner pane, there will be a masking layer between the outer pane and the coated metal foil. If an additional masking layer (e.g. an opaque masking print) is arranged closer to the inner pane, this masking layer will be provided with one or more openings in order to ensure a clear view of the reflective surface from the interior.

In an alternative embodiment, the masking layer is designed as an opaquely colored region of the thermoplastic intermediate layer. In one embodiment, the thermoplastic intermediate layer is formed in one piece and is opaquely colored in one region.

A masking layer formed as an opaquely colored region of the thermoplastic intermediate layer can also be achieved by using a thermoplastic intermediate layer composed of an opaque thermoplastic foil and a transparent thermoplastic foil. The opaque thermoplastic foil and transparent thermoplastic foil are preferably arranged offset from one another, so that in a view through the laminated pane the two films are not overlapping. The transparent and the opaque film consist of the same plastic or preferably contain the same plastic. The materials on the basis of which the opaque foil and the transparent foil can be formed are those which are also described for the first thermoplastic intermediate layer. The opaque film is preferably a colored film which can have different colors, in particular black.

The laminated pane according to the invention can in particular have an opaque masking print arranged on the interior-side surface of the inner pane, in particular at least in the region in which the metal foil is arranged. Such a masking print on the interior-side surface of the inner pane improves the adhesion properties of the surface relative to an adhesive layer. The opaque masking print is preferably designed in the shape of a frame.

The adhesive layer is preferably a thermoplastic layer or an optical clear adhesive (OCA). Suitable optical clear adhesives (OCA) are known to a person skilled in the art. The adhesive layer formed as a thermoplastic layer comprises at least one thermoplastic polymer, preferably ethylene vinyl acetate (EVA), polyvinyl butyral (PVB) or polyurethane (PU) or mixtures or copolymers or derivatives thereof, particularly preferably PVB. The thermoplastic layer is typically formed from a thermoplastic film (joining film). The thickness of the thermoplastic layer is preferably from 0.2 mm to 2 mm, particularly preferably from 0.3 mm to 1 mm, for example 760 μm. The thermoplastic layer can be formed by a single film or also by more than one film. The metal foil can be firmly bonded to the inner pane by lamination, for example.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer, via which the outer pane is joined to the inner pane, contains at least one thermoplastic polymer, preferably ethylene vinyl acetate (EVA), polyvinyl butyral (PVB) or polyurethane (PU) or mixtures or copolymers or derivatives thereof, particularly preferably PVB. The thermoplastic intermediate layer is typically formed from a thermoplastic film (joining film). The thickness of the thermoplastic intermediate layer is preferably from 0.2 mm to 2 mm, particularly preferably from 0.3 mm to 1 mm, for example 760 μm. The thermoplastic intermediate layer may be formed by a single film or also by more than one film. The thermoplastic intermediate layer can also be a film with functional properties, for example a film with acoustic damping properties.

The outer pane and the inner pane preferably contain or consist of glass, particularly preferably flat glass, float glass, quartz glass, borosilicate glass, soda-lime glass, alumino-silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can be clear and colorless, but also tinted or colored. In a preferred embodiment, the total transmission through the windshield is greater than 70% in the main see-through region (light type A). The term total transmission relates to the method defined by ECE-R 43, Annex 3, § 9.1 for testing the light transmittance of motor vehicle panes. Independently of one another, the outer pane and the inner panes can be not prestressed, partially prestressed or prestressed. If at least one of the panes is to be prestressed, this can be thermal or chemical prestressing.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm, very particularly preferably of 1.6 mm to 2.1 mm. For example, the outer pane has a thickness of 2.1 mm, and the inner pane has a thickness of 1.6 mm. However, the outer pane or, in particular, the inner pane can also be a thin glass with a thickness of 0.55 mm, for example.

The laminated pane according to the invention can comprise one or more additional intermediate layers, in particular functional intermediate layers. An additional intermediate layer can be, in particular an intermediate layer with acoustically damping properties, an intermediate layer reflecting infrared radiation, an intermediate layer absorbing infrared radiation, an intermediate layer absorbing UV radiation, a layer that is colored at least in portions, and/or an intermediate layer that is tinted at least in portions. If there is a plurality of additional intermediate layers, they can also have different functions.

The invention also relates to a projection assembly that comprises a laminated pane according to the invention and an imaging unit directed towards the reflective surface.

Also according to the invention, therefore, is a projection assembly which comprises:
a laminated pane, comprising at least an outer pane having an outer-side surface and an interior-side surface, a thermoplastic intermediate layer, an inner pane having an outer-side surface and an interior-side surface, at least one masking layer arranged in a region of the laminated pane between the outer pane and the inner pane, an adhesive layer and a metal foil having an outer-side surface and an interior-side surface on which a reflective surface for reflecting light is arranged, wherein the thermoplastic intermediate layer is arranged between the outer pane and the inner pane, the adhesive layer is arranged between the inner pane and the metal foil, and wherein the metal foil is arranged in a region of the laminated pane which, when viewed perpendicularly through the laminated pane, lies completely within the region in which the masking layer is arranged,
and an imaging unit directed at the reflective surface.

In particular, in the case of the projection assembly according to the invention the combination of reflective surface with the masking layer that is behind it from the perspective of a vehicle occupant brings about a good visibility of the image, even in the case of external solar irradiation and when attenuated-light imaging units are used. Even under these circumstances, the image generated by the imaging unit appears bright and can be seen perfectly. This enables a reduction in the power of the imaging unit and thus a reduced energy consumption.

From the viewpoint of a vehicle occupant, the reflective surface is arranged spatially in front of the masking layer in a view through the inner pane. As a result, the region of the laminated pane in which the reflective surface is arranged appears opaque. The expression “in a view through the laminated pane” means looking through the laminated pane starting from the interior-side surface of the laminated pane. The expression “spatially in front of,” within the meaning of the present invention, means that the reflective surface is arranged spatially further away from the outer-side surface of the outer pane than the masking layer. Preferably, the masking layer is widened at least in the region which overlaps with the reflective surface and in which the laminated pane is used for displaying images. This means that when viewed perpendicular to the closest portion of the peripheral edge of the laminated pane, the masking layer in this region has a greater width than in other portions. In this way, the masking layer can be adapted to the dimensions of the reflective surface.

The imaging unit of the projection assembly emits light and is arranged in the vicinity of the interior-side surface of the inner pane such that the imaging unit irradiates this surface, wherein the light is reflected by the reflective surface of the laminated pane. The reflective surface reflects preferably at least 10%, particularly preferably at least 50%, very particularly preferably at least 80%, and in particular at least 90% of the light impinging upon the reflective surface in a wavelength range of 400 nm to 700 nm and irradiation angles of 55° to 80°. This is advantageous for achieving the highest possible brightness of an image emitted by the imaging unit and reflected on the reflective surface.

The imaging unit serves to emit an image and can thus also be referred to as a projector, display device or image display device. A display or other device known to a person skilled in the art, for example, can be used as the imaging unit. The imaging unit is preferably a display, particularly preferably an LCD display, LED display, OLED display or electroluminescent display, in particular an LCD display. Displays have a low installation height and are thus simply integrated into the dashboard of a vehicle in a space-saving manner. Moreover, displays can be operated in a significantly more energy-saving manner than other imaging units. The comparatively lower brightness of displays is entirely sufficient in the combination according to the invention of the reflective surface and the masking layer located behind it. The radiation of the imaging unit impinges in the region of the reflective surface preferably at an angle of incidence of 55° to 80° on the laminated pane, more preferably of 62° to 77° on the laminated pane. The angle of incidence is the angle between the incidence vector of the radiation of the image display device and the surface normal in the geometric center of the reflective surface.

Due to the fact that the reflective surface is arranged on the outer-side surface of a metal foil glued to the interior-side surface or the outer-side surface of the inner pane, the appearance of a disturbing ghost image is prevented.

With a projection assembly having a reflective surface arranged on the interior-side surface of the metal foil, the desired virtual image is created by reflection on the reflective surface and no ghost image appears.

The preferred designs of the laminated pane according to the invention described above also correspondingly apply to the projection assembly according to the invention and vice versa.

According to the invention, there is also a method for producing a laminated pane according to the invention comprising:
a) producing a laminate of an outer pane having an outer-side surface and an interior-side surface, a thermoplastic intermediate layer and an inner pane having an outer-side surface and an interior-side surface, wherein the thermoplastic intermediate layer is arranged between the outer pane and the inner pane and at least one masking layer is arranged in a region between the outer pane and the inner pane;
b) providing a metal foil having an outer-side surface and an interior-side surface on which a reflective surface for reflecting light is arranged;
c) joining the metal foil to the inner pane via an adhesive layer in such a way that the metal foil is arranged in a region of the laminated pane which, when viewed perpendicularly through the laminated pane, lies completely within the region in which the masking layer is arranged.

Steps a), b) and c) can be performed in the order given, simultaneously or in any order. In particular, step c) can be performed before or after step a). Step a) is performed after step c) of the coated glass pane has been applied to the outer-side surface (side III) of the inner pane. Step c) can be performed after step a) if the coated glass pane has been applied to the interior-side surface (side IV) of the inner pane.

As explained above, the metal foil is arranged only in a region of the laminated pane which, when viewed perpendicularly through the laminated pane, lies completely within the region in which the masking layer is arranged. The external dimensions of the metal foil are thus smaller than the outer pane and the inner pane of the laminated pane. A reflective surface can be selectively arranged in a region of the laminated pane via the reflective surface arranged on the metal foil.

The provision of the metal foil in step b) can additionally comprise the application of a protective layer to the reflective surface applied to the interior-side surface. The protective layer is preferably applied to the reflective surface by means of spraying, for example with a pressure atomizer.

If the laminated pane is to be curved, a curved outer pane and a curved inner pane are used when providing the laminate in step a). The metal foil with the reflective surface is flexible due to the low thickness of the metal foil and adapts to the curved inner pane in step c). This is an advantage of the method according to the invention.

The production of the laminate in step a) can be effected by means of lamination methods familiar to a person skilled in the art.

The preferred embodiments of the laminated pane according to the invention described above also correspondingly apply to methods for producing a laminated pane according to the invention.

The invention also relates to the use of a laminated pane according to the invention as a vehicle pane in a means of transport for traffic on land, in the air or on water, in particular in motor vehicles and in particular as a windshield for a head-up display.

The various embodiments of the invention may be implemented individually or in any combinations. In particular, the features mentioned above can be used not only in the specified combinations but also in other combinations or alone without departing from the scope of the present invention.

The invention is explained in more detail below with reference to exemplary embodiments, wherein reference is made to the accompanying figures. In a simplified, not-to-scale representation:

FIG. 1 shows a plan view of an embodiment the laminated pane according to the invention,

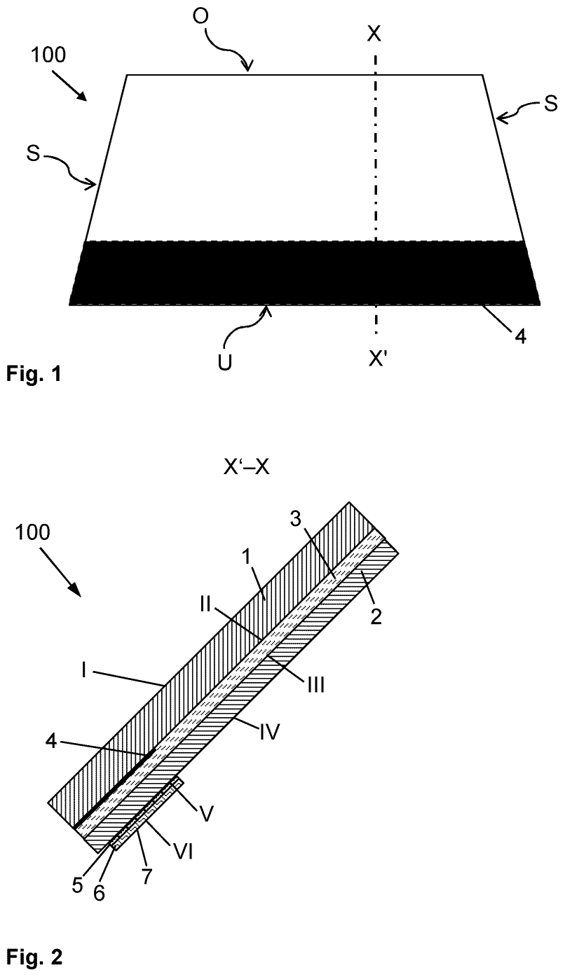

FIG. 2 shows a cross-section through the embodiment shown in FIG. 1,

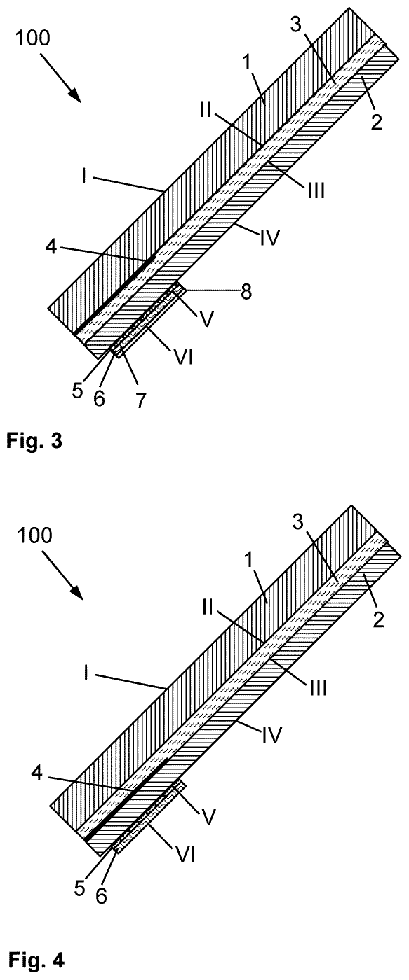

FIG. 3 shows a cross-section through a further embodiment of the laminated pane according to the invention,

FIG. 4 shows a cross-section through a further embodiment of the laminated pane according to the invention,

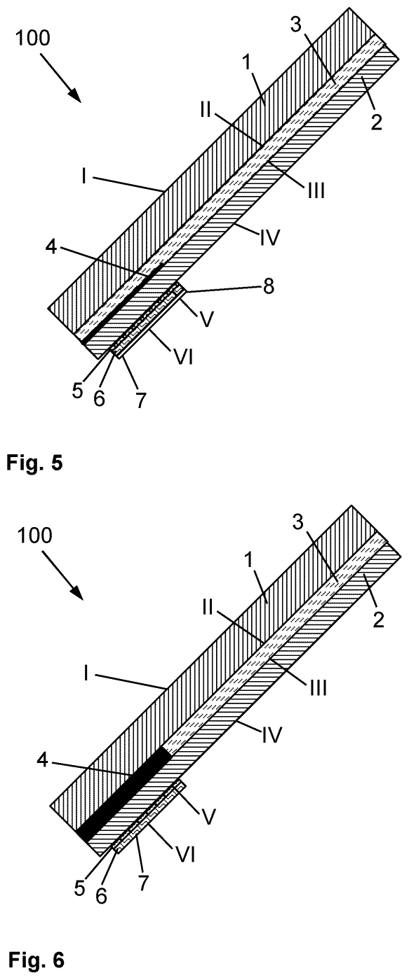

FIG. 5 shows a cross-section through a further embodiment of the laminated pane according to the invention,

FIG. 6 shows a cross-section through a further embodiment of the laminated pane according to the invention,

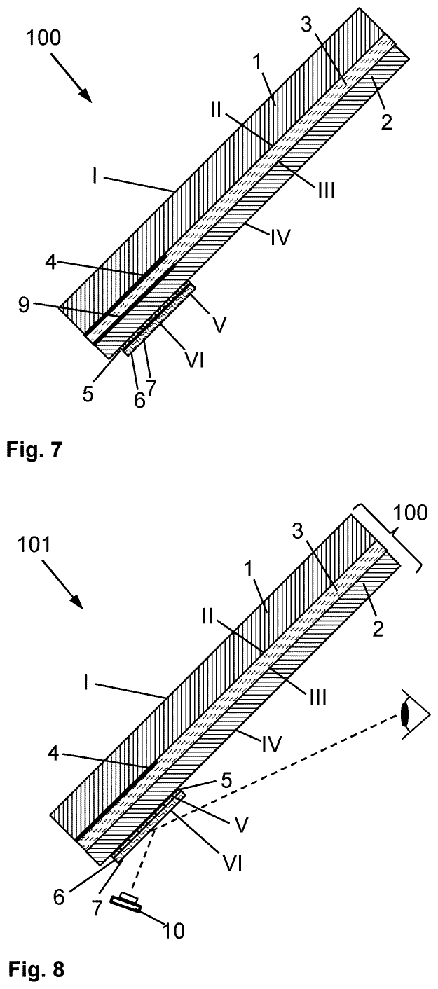

FIG. 7 shows a cross section through a further embodiment of the laminated pane according to the invention,

FIG. 8 shows a cross-section through an embodiment of a projection assembly according to the invention,

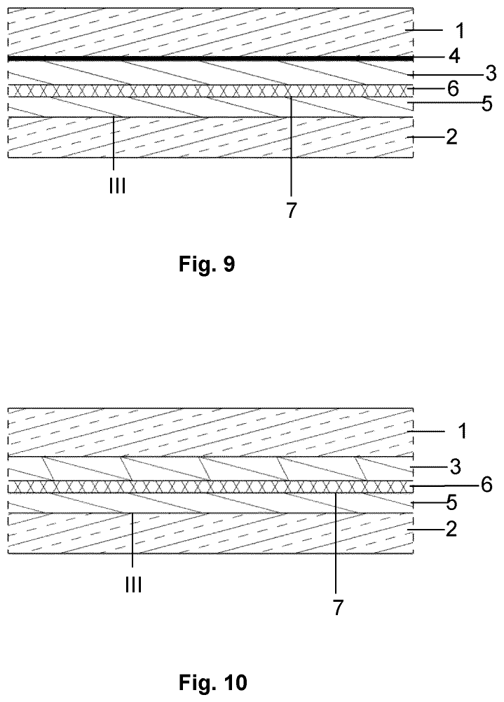

FIG. 9 shows a cross-section through a further embodiment of a laminated pane according to the invention,

FIG. 10 shows a cross-section through a further embodiment of a laminated pane according to the invention,

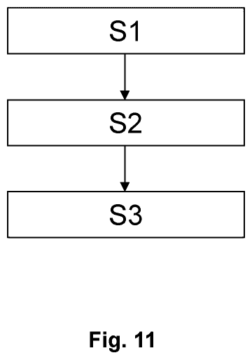

FIG. 11 shows with the aid of a flow chart an exemplary embodiment of the method according to the invention.

FIG. 1 shows a plan view of an embodiment of the laminated pane 100 according to the invention and in FIG. 2 a cross-section through the laminated pane 100 according to the invention shown in FIG. 1 along the cutting line X-X′. The laminated pane 100 shown in FIGS. 1 and 2 has an upper edge O, a lower edge U and two side edges K. Furthermore, the laminated pane 100 comprises an outer pane 1 having an outer-side surface I and an interior-side surface II, an inner pane 2 having an outer-side surface III and an interior-side surface IV, a thermoplastic intermediate layer 3, a masking layer 4, an adhesive layer 5 and a metal foil 6 having an outer-side surface V and an interior-side surface VI. The thermoplastic intermediate layer 3 is arranged between the outer pane 1 and the inner pane 2, the inner pane 2 is arranged between the outer pane 1 and the metal foil 6, and the adhesive layer 5 is arranged between the inner pane 2 and the metal foil 6. The outer pane 1, the thermoplastic intermediate layer 3 and the inner pane 2 are arranged stacked over one another over the entire surface. The masking layer 4 is arranged between the outer pane 1 and the inner pane 2 in a region of the laminated pane 100, the areal extent of which is smaller than the areal extent of the laminated pane 100; i.e. the masking layer 4 does not extend over the entire surface of the laminated pane 100. In the embodiment shown in FIGS. 1 and 2, the masking layer 4 is designed as a first opaque masking print arranged on the interior-side surface II of the outer pane 1 and is arranged only in an edge region of the laminated pane 100 bordering the lower edge U. The metal foil 6 is arranged in a region of the laminated pane 100 which, when viewed vertically through the laminated pane 100, lies completely within the region in which the masking layer 4 is arranged. The metal foil 6 is thus smaller in terms of its external dimensions than the inner pane 2. The outer-side surface V of the metal foil 6 is joined to the interior-side surface IV of the inner pane 2 via the adhesive layer 5. In the embodiment shown in FIG. 2, a reflective surface 7 for reflecting light is formed on the interior-side surface VI of the metal foil 6; i.e. the interior-side surface of the metal foil itself serves as the reflective surface 7.

The metal foil 6, for example, is made of stainless steel and has a thickness of, for example, 90 μm. The thermoplastic intermediate layer 3 contains PVB, for example, and has a thickness of 0.76 mm. The outer pane 1 consists, for example, of soda lime glass and is 2.1 mm thick. The inner pane 2 consists, for example, of soda lime glass and is 1.6 mm thick.

The adhesive layer 5 consists, for example, of an optically clear adhesive. Alternatively, the adhesive layer 5 consists of a thermoplastic material, such as polyvinyl butyral (PVB), and the metal foil 6 has been joined to the inner pane 2 by lamination.

It should be understood that the laminated pane 100 can have any suitable geometric shape and/or curvature. Typically, the laminated pane 100 is a curved laminated pane. The laminated pane 100 is, for example, the windshield of a motor vehicle.

In the embodiment shown in FIGS. 1 and 2, the masking layer 4 extends between the two side edges S of the laminated pane 100 and, starting from the lower edge U of the laminated pane 100, has a width of, for example, 30 cm.

FIG. 3 shows a cross-section through a further embodiment of a laminated pane 100 according to the invention. The embodiment shown in cross-section in FIG. 3 (analogous to FIG. 2) differs from that shown in FIG. 2 only in that a protective layer 8 is additionally applied to the entire surface VI of the metal foil 6 on the interior-side surface. The protective layer 8 is preferably a polymer based on polyacrylates, polyoximes, alkyd resins, polyurethanes or mixtures thereof. For example, the protective layer contains SiO₂, Si₃N4 or TiO₂, or consists thereof. The protective layer 8 has, for example, a thickness of 500 nm.

FIG. 4 shows a cross-section through a further embodiment of the laminated pane 100 according to the invention. The embodiment shown in FIG. 4 in cross-section (analogous to FIG. 2) differs from that shown in FIG. 2 only in that the masking layer 4 is not formed as a first opaque masking print arranged on the interior-side surface II of the outer pane 1, but is formed as a first opaque masking print arranged on the outer-side surface III of the inner pane 2.

FIG. 5 shows a cross-section through a further embodiment of a laminated pane 100 according to the invention. The embodiment shown in FIG. 5 in cross-section differs from that shown in FIG. 4 only in that a protective layer 8 is additionally applied to the entire surface of the interior-side surface VI of the metal foil 6 (analogous to FIG. 3).

FIG. 6 shows a cross-section through a further embodiment of the laminated pane 100 according to the invention. The embodiment shown in FIG. 6 in cross-section differs from that shown in FIG. 2 only in that the masking layer 4 is not formed as a first opaque masking print arranged on the interior-side surface II of the outer pane 1, but is formed as an opaque colored region of the thermoplastic intermediate layer 3.

FIG. 7 shows a cross-section through a further embodiment of a laminated pane 100 according to the invention. The embodiment shown in FIG. 7 in cross-section differs from that shown in FIG. 2 only in that the laminated pane 100 additionally has a second opaque masking print 9 applied to the outer-side surface III of the inner pane 2.

FIG. 8 shows a cross-section through an embodiment of the projection assembly 101 according to the invention. The projection assembly 101 shown in FIG. 16 comprises a laminated pane 100 and an imaging unit 10. The projection assembly 101 has an imaging unit 10. The imaging unit 10 is used to generate p-polarized light and/or s-polarized light (image information), which is directed onto the reflecting surface 7 and is reflected by the reflecting surface 7 as reflected light into the vehicle interior, where it can be perceived by a viewer, e.g. a driver. The reflecting surface 7 is designed to be suitable for reflecting the light of the imaging unit 10. The light impinges on the reflecting surface 7 preferably at an angle of incidence of 55° to 80°, in particular 62° to 77°. The imaging unit 10 is, for example, a display, in particular an LCD display. Preferably, the imaging unit 10 serves to generate only p-polarized light, which can be seen well, in particular, with polarizing sunglasses that have an s-polarization filter.

In the following, further embodiments of the laminated pane 100 according to the invention (FIGS. 9 and 10) are illustrated with the aid of cross-sections. In the further embodiments in FIGS. 9 and 10 of the laminated pane 100 according to the invention, the metal foil 6 is arranged on the outer-side surface (side III) of the inner pane 2. These embodiments can equally be used in the projection assembly 101 illustrated by way of example in FIG. 8.

FIG. 9 shows a cross-section through a further embodiment of a laminated pane 100 according to the invention. The cross-section is only shown in the region of the metal foil 6. The embodiment shown in cross-section in FIG. 9 differs from that shown in FIG. 2 only in that the metal foil 6 is attached to the outer-side surface III of the inner pane 2. The adhesive layer 5 is located between the metal foil 6 and the outer-side surface (side III) of the inner pane 2. The reflective surface 7 is arranged on the interior-side surface VI of the metal foil 6 or is formed thereby. It would equally be possible for the masking layer 4 to be arranged alternatively or as an additional masking layer on the outer-side surface (side III) of the inner pane 2. In this case, the masking layer arranged on side III has one or more openings, in order to ensure a clear view of the reflective surface 7.

FIG. 10 shows a cross-section through a further embodiment of a laminated pane 100 according to the invention. The cross-section is only shown in the region of the metal foil 6. The embodiment shown in cross-section in FIG. 10 differs from that shown in FIG. 6 in that the metal foil 6 is attached to the outer-side surface III of the inner pane 2. The adhesive layer 5 is located between the metal foil 6 and the outer-side surface (side III) of the inner pane 2.

An exemplary embodiment of the method according to the invention is shown in FIG. 11 with the aid of a flow chart.

In a step S1, a laminate is produced from an outer pane 1 having an outer-side surface I and an interior-side surface II, a thermoplastic intermediate layer 3 and an inner pane 2 having an outer-side surface III and an interior-side surface IV, wherein the thermoplastic intermediate layer 3 is arranged between the outer pane 1 and the inner pane 2 and a masking layer 4 is arranged in a region between the outer pane 1 and the inner pane 2.

In a step S2, a metal foil 6 having an outer-side surface V and an interior-side surface VI is provided, wherein a reflective surface 7 for reflecting light is arranged on the interior-side surface VI of the metal foil 6.

In a third step S3, the metal foil 6 is joined to the inner pane 2 via an adhesive layer 5 to form a laminated pane 100, in such a way that the metal foil 6 is arranged in a region of the laminated pane 100 which, when viewed perpendicularly through the laminated pane 100, lies completely within the region in which the masking layer 4 is arranged.

Steps S1, S2 and S3 can be performed in any order or simultaneously.

From the above, it follows that the invention provides an improved laminated pane, with which the image of a projector is reflected and the virtual image is visually perceptible with sufficient brightness and high contrast, so that good discernability, in particular of safety-relevant information, is reliably ensured in all weather and lighting conditions. In addition, unwanted secondary images can be prevented. The laminated pane can be produced efficiently and cost-effectively in industrial series production, and the production of the laminated pane can be easily implemented in common production processes.

### LIST OF REFERENCE SIGNS

100 Laminated pane
101 Projection assembly
1 Outer pane
2 Inner pane
3 Thermoplastic intermediate layer
4 Masking layer
5 Adhesive layer
6 Metal foil
7 Reflective surface
8 Protective layer
9 Second opaque masking print
10 Imaging unit
O Upper edge of the laminated pane 100
U Lower edge of the laminated pane 100
S Side edge of the laminated pane 100
I Outer-side surface of the outer pane 1
II Interior-side surface of the outer pane 1
III Outer-side surface of the inner pane 2
IV Interior-side surface of the inner pane 2
V Outer-side surface of the outer pane 6
VI Interior-side surface of the metal foil 6

1. A laminated pane, comprising:
an outer pane having an outer-side surface and an interior-side surface,
a thermoplastic intermediate layer,
an inner pane having an outer-side surface and an interior-side surface,
at least one masking layer,
an adhesive layer,
a metal foil having an outer-side surface and an interior-side surface on which a reflective surface for reflecting light is arranged,
wherein the thermoplastic intermediate layer is arranged between the outer pane and the inner pane, the at least one masking layer is arranged between the outer pane and the inner pane in a region of the laminated pane, the adhesive layer is arranged between the inner pane and the metal foil, and wherein the metal foil is arranged in a region of the laminated pane which, when viewed perpendicularly through the laminated pane, lies completely within the region in which the at least one masking layer is arranged.

2. The laminated pane according to claim 1, wherein the metal foil has a thickness of less than 200 μm.

3. The laminated pane according to claim 1, wherein the metal foil consists of stainless steel.

4. The laminated pane according to claim 1, wherein the reflective surface of the metal foil is polished and the interior-side surface of the metal foil is roughened.

5. The laminated pane according to claim 1, wherein the reflective surface of the metal foil is provided with a smoothing layer.

6. The laminated pane according to claim 5, wherein the smoothing layer contains or consists of nickel.

7. The laminated pane according to claim 1, wherein at least the reflective surface is provided with a protective layer.

8. The laminated pane according to claim 1, wherein the metal foil is arranged on the interior-side surface or on the outer-side surface of the inner pane.

9. The laminated pane according to claim 1, wherein the reflecting surface of the metal foil reflects at least 10% of visible light.

10. The laminated pane according to claim 1, wherein the at least one masking layer is formed as an opaque masking print arranged on the interior-side surface of the outer pane and/or the outer-side surface of the inner pane.

11. The laminated pane according to claim 1, wherein the masking layer is designed as an opaquely colored region of the first thermoplastic intermediate layer.

12. The laminated pane according to claim 1, wherein the adhesive layer is a thermoplastic polymer layer or an optically clear adhesive.

13. A projection assembly comprising:
a laminated pane according to claim 1,
an imaging unit directed onto the reflective surface of the metal foil.

14. A method for producing a laminated pane according to claim 1, comprising:
a) producing a laminate from an outer pane having an outer-side surface and an interior-side surface, a thermoplastic intermediate layer and an inner pane having an outer surface and an interior-side surface, wherein the thermoplastic intermediate layer is arranged between the outer pane and the inner pane and at least one masking layer is arranged in a region between the outer pane and the inner pane;
b) providing a metal foil having an outer-side surface and an interior-side surface on which a reflective surface for reflecting light is arranged;
c) joining the metal foil to the inner pane via an adhesive layer in such a way that the metal foil is arranged in a region of the laminated pane which, when viewed perpendicularly through the laminated pane, lies completely within the region in which the at least one masking layer is arranged.

15. A method comprising providing the laminated pane according to claim 1 as a vehicle pane in a vehicle of transport for traffic on land, in the air or on water.

16. The laminated pane according to claim 2, wherein the metal foil has a thickness of less than 100 μm.

17. The laminated pane according to claim 9, wherein the reflecting surface of the metal foil reflects at least 50% of visible light.

18. The laminated pane according to claim 17, wherein the reflecting surface of the metal foil reflects at least 80% of visible light.

19. The laminated pane according to claim 18, wherein the reflecting surface of the metal foil reflects at least 90% of visible light.

20. The method according to claim 15, wherein the vehicle is a motor vehicle and/or the laminated pane is a windshield for a head-up display.
